(19) United States
(12) Patent Application Publication
(10) Pub. No.: US 2020/0037618 A1
(43) Pub. Date: Feb. 6, 2020

(54) unknown

(71) Applicant: R. Weiss Verpackungstechnik GMBH & Co. KG, Crailsheim (DE)

(72) Inventor: Reinald Weiss, Schopfloch (DE)

(21) Appl. No.: 16/528,852

(22) Filed: Aug. 1, 2019

(30) Foreign Application Priority Data
Aug. 1, 2018 (DE) 10 2018 118 710.6

(51) Int. Cl. A21B 7/00; G06Q 10/04; G06Q 10/06

(52) U.S. Cl. CPC A21B 7/00; G06Q 10/04; G06Q 10/06393; G06Q 10/0637; G06Q 10/06315

(57) ABSTRACT

The invention relates to a method for the optimized provision of goods, in particular baked goods, for customer purchase, in particular in a supermarket, wherein goods are fed to at least one treatment device, in particular, to at least one baking oven and the goods are treated, in particular baked, in the treatment device and offered to customers for purchase. An operator is provided action recommendations via a display of a hardware device for loading the treatment devices with goods to be treated, wherein a computer program installed on a computer is provided for calculating the aforementioned action recommendations. The invention also relates to a corresponding system.

### FIELD OF THE INVENTION

The present invention relates to a method for the optimized provision of goods and to a corresponding system.

### PRIORITY CLAIMS

This application claims priority to German Patent Application Number 10 2018 118 710.6 filed Aug. 1, 2018.

### BACKGROUND OF THE INVENTION

It is known, for example, to freshly prepare goods in supermarkets and to offer them there directly for sale. Baked goods, in particular, have been freshly prepared for some time now, for example in automatic baking machines, or baked on site by hand. In both cases the dough is delivered to the supermarket. However, it is not always possible to avoid either too few or too many baked goods from being ordered by the supermarket and/or from being requested by the customer in the supermarket.

It is an object of the present invention to provide a method and a system for the optimized provision of treated goods, in particular baked goods, for customers on sales premises.

This object is achieved by a method and a system including the features of the independent claims.

### DETAILED DESCRIPTION OF THE INVENTION

The method according to the invention and the system according to the invention are designed to better satisfy the demand for freshly produced goods, in particular baked goods, via computer-aided process control. The method preferably includes automated forecast calculations, a comparison with current actual values, cost-effective treatment of uncertainties and generation of action recommendations throughout the day.

To achieve this goal, goods, in particular baked goods, are fed to and treated, in particular baked, in at least one treatment device, in particular at least one oven, in order to then offer them to customers for purchase. In order to achieve optimized provision, a real-time inventory management is established, an important element being that an operator of the at least one treatment device is provided action recommendations via a display of a hardware device for loading the treatment devices with goods to be treated. These action recommendations are calculated by a computer program, wherein this computer program runs on a server set up in the supermarket or at an external facility. In the latter case, the server may perform the necessary calculations, in particular, for a plurality of supermarkets.

The aforementioned computer program calculates the target expected quantities of the goods to be treated (i.e., the production quantities) based at least on customer demand forecasts relating to the goods, preferably taking into account a security buffer for the goods, thereby allowing bottlenecks to be cushioned, if not completely prevented, even in case of unforeseen events (e.g., unpredicted over-withdrawal of goods of a particular product type within a certain period of time).

As explained, the target expected quantities of the various goods for a supermarket required for a day are calculated by the computer program, and are preferably divided on the basis of the intraday distribution into constant intervals of a few minutes, for example into a constant interval of between 3 to 20 minutes, preferably between 5 and 10 minutes. The corresponding target expected quantities are then advantageously aggregated to full hours. In the individual intervals, customer pre-orders, including the respective pick-up time, are taken into account when calculating the target expected values. In this case, a dynamic, cost-optimal surcharge per hour interval is advantageously calculated as the aforementioned security buffer for complying with a targeted service level, preferably including an optionally desired stock present at store closing time.

The computer program performs a real-time target/actual comparison for generating a real-time forecast, wherein the computer program on the one hand uses the aforementioned target expected quantities and on the other hand takes into account at least some of the following parameters when calculating the actual status: customer pre-orders, including the pick-up time, current sales of goods, current weather, treatment times of the goods in the respective treatment devices, inputs from operators with respect to the at least one treatment device, machine data for the at least one treatment device and/or different computer-aided control programs running on the at least one treatment device.

The machine data include, for example, set-up times, heating times of a baking oven and the respective energy consumption of the treatment devices.

The inputs from the operator may, for example, be parameters set for the at least one treatment device, which apply to different goods and/or quantities of goods, for example, in the case of different baked goods, their associated baking times.

The current weather may be important, since experience shows that fewer goods are sold, for example, during rainy weather. On the other hand, the weather expected, for example, in the next few hours may be included as a parameter when calculating the target expected values.

Installed in the at least one treatment device are preferably several different computer-aided control programs, which provide different treatments for different goods, for example, the baking time in the case of a baking oven and also the transport speed of goods through the oven in the case of a continuous baking oven.

The computer program carrying out the target-actual comparison, as a function of the result of this comparison, causes the action recommendations to be displayed on the display of the aforementioned hardware device of the operator. A corresponding data transmission from the computer or server may be implemented preferably wirelessly or wire based.

According to one preferred embodiment, the computer program is designed in such a way that it computationally optimizes at least one of the following target variables: degree of availability of goods as a function of time, degree of filling of at least one treatment device, loss rate of goods not sold, turnover as a function of time, number of filling operations as a function of time, average storage time of the treated goods until their sale, desired stock present at store closing time and/or surplus costs for surplus goods. Some or all of the aforementioned target variables are advantageously included in the calculations in order, for example, to optimize the degree of filling of the treatment devices, which not only benefits optimal utilization but also improved energy efficiency. In this case, it may be particularly advantageous for the computer program to prioritize larger treatment devices, for example larger baking ovens, relative to smaller treatment devices.

The aforementioned action recommendations are preferably displayed to the operator of the at least one treatment device on a portable hardware device, in particular, on a tablet or on a smartphone. These devices are easy to handle and convenient to carry.

The action recommendations are preferably presented to the operator—optionally also to other persons, such as the store manager—on the display of the hardware device with the aid of an application software (“app”) including a corresponding user interface.

At least some of the following pieces of information and action recommendations are preferably displayed on the display of the hardware device: the time of each action to be taken, identification of the treatment device to be operated by the operator (if multiple treatment devices are present), the control program to be set by the operator for the relevant treatment device, the articles to be introduced into the at least one treatment device, the number of corresponding goods or devices in which goods are introduced and/or an indication of a current or future need or lack of need of goods to be treated, preferably in quantified form, i.e., indicating the number of the relevant good or goods.

The hardware device particularly preferably allows a completion of the action recommendation by the operator to be entered. After this acknowledgment, the display of the hardware device preferably indicates this completion, wherein the corresponding input is advantageously processed by the computer program for the aforementioned action recommendation. In this case, the operator preferably acknowledges the quantities of goods proposed in the action recommendation and/or the corresponding treatment program (for example a baking program) after he/she has filled the relevant treatment device with the goods and has started the treatment process. If a specification is not acknowledged as completed in the proposed time period, the operator is preferably made aware of this visually and/or acoustically via corresponding output means on the hardware device.

The pieces of information displayed on the hardware device including the action recommendations and the inputs of the operator via the user interface are preferably all implemented using the aforementioned application software (“app”) to be processed by the processor of the hardware device. The application software may also—upon receipt of the appropriate information from the aforementioned computer program—cause the display of a piece of information on the hardware device that a treatment device must be cleaned. The computer program calculates this need for cleaning, for example, after reaching a predetermined operating time of the respective treatment device and/or after receiving a corresponding signal from the treatment device. This signal may be a time signal and/or a signal from a sensor that measures a degree of contamination of the treatment device.

The aforementioned computer program also advantageously calculates a division into lot sizes for the treatment of goods, wherein one or multiple of the following parameters are included in the calculation: current and/or future occupancies and capacities of the treatment devices, treatment times for the goods in the treatment devices and/or set-up times of the treatment devices. In this case, the lot sizes ascertained are assigned to respective treatment devices and to corresponding control programs of the respective treatment device. An optimized, time saving and energy saving occupancy of the treatment device may be implemented in this way.

The invention also relates to a system for the optimized provision of goods for customers, which is designed according to the independent device claim. The features and associated advantages of the system according to the invention will become apparent from the aforementioned.

1-13. (canceled)

14. A method for the optimized provision of baked goods for customer purchase, comprising:
feeding goods into a baking oven;
baking the goods in the baking oven to create baked goods;
offering the baked goods to customers for purchase;
providing an operator of the baking oven recommendations for feeding the goods into the baking oven through a display of a hardware device;
providing a computer program installed on a computer for calculating the recommendations, wherein the computer program:
calculates target baked goods based on customer demand forecasts and a security buffer relating to the baked goods;
calculates actual baked goods based on at least one of customer pre-orders, customer pick-up time, current sales of baked goods, current weather, bake times of the goods, input from the operator of the baking oven, input from another operator of the baking oven, machine data from the baking oven, or a computer-aided control program running on the baking oven;
performs a real time comparison between the target baked goods and the actual baked goods; and
causes the recommendations to be displayed on the display of the hardware device.

15. The method as in claim 14, wherein the computer program optimizes at least one of the following target baked goods variables: the degree of availability of baked goods as a function of time, the degree of filling at least one baking oven with goods, the rate of loss of non-sold baked goods, the turnover of baked goods as a function of time, the number of filling operations as a function of time, the average storage time of the baked goods until their sale, the desired inventory of baked goods at store closing time, or the surplus costs for surplus baked goods.

16. The method as in claim 14, further comprising displaying the recommendations on a tablet or on a smartphone.

17. The method as in claim 14, further comprising displaying at least one of the following pieces of information or recommendations on the display of the hardware device: a time for taking each recommendation; an identification of the baking oven to be selected in the case of several baking ovens; a control program to be set for the relevant baking oven; articles to be introduced into at least one baking oven; a number of corresponding goods or baking ovens with goods introduced; or an indication of a need or lack of need of goods to be baked.

18. The method as in claim 14, further comprising entering into the hardware device completion of the recommendations by the operator and displaying on the display of the hardware device completion of the recommendations.

19. The method as in claim 14, wherein the computer program divides the baked goods into lot sizes based on at least one of the following parameters: current capacity of the baking oven, current goods in the baking oven, baking times for the goods in the baking oven, or set-up time of the baking oven.
